(19) United States
(12) Patent Application Publication
(10) Pub. No.: US 2019/0386762 A1
(43) Pub. Date: Dec. 19, 2019

(54) DATE PROCESSING SYSTEM AND METHOD

(71) Applicant: GUANGDONG VIRTUAL REALITY TECHNOLOGY CO., LTD., Shenzhen (CN)

(72) Inventors: Xiasen PIAO, Shenzhen (CN); Jingwen DAI, Shenzhen (CN); Jie HE, Shenzhen (CN)

(21) Appl. No.: 16/554,648

(22) Filed: Aug. 29, 2019

Related U.S. Application Data
(63) Continuation of application No. PCT/CN2017/096312, filed on Aug. 7, 2017.

(30) Foreign Application Priority Data
Apr. 24, 2017 (CN) 201710273573.5

(51) Int. Cl. H04J 3/06; H04L 29/06

(52) U.S. Cl. CPC H04J 3/0667; H04L 67/38; H04J 3/0682

(57) ABSTRACT

A time synchronization system is disclosed. The system includes a host, a first device and a second device, each of the host, the first device and the second device has a time system respectively. The first device is configured to send a first signal to the second device at a local time T2 of the first device according to a control command sent from the host, the first signal is a signal that transmitted in the wireless channel with a fixed duration. The second device is configured to receive the first signal sent from the first device at a local time T3 of the second device, and send first data carrying the time T3 to the host. The host is configured to acquire the time T2 from the control command, receive the first data carrying the time T3 sent from the second device, and determine a system time difference between the time systems corresponding to the first device and the second device according to the time T2, the time T3, and a preset ΔIR, wherein the ΔIR is a fixed duration of the first signal transmitted from the first device to the second device.

### CROSS-REFERENCE TO RELATED APPLICATIONS

This application is a continuation application of International Application No. PCT/CN2017/096312, filed on Aug. 7, 2017, which claims priority to Chinese Patent Application No. 201710273573.5, filed on Apr. 24, 2017. The disclosures of the aforementioned patent applications are hereby incorporated by reference in their entireties.

### TECHNICAL FIELD

The present disclosure relates to the field of date transmission, and in particular, to a date processing method, and a date processing system in a virtual reality or augmented reality system.

### BACKGROUND

Data interaction is essential in data transmission system, such as in a virtual reality or augmented reality system. Time systems used by different systems are independent, relatively. In the data interaction process of multiple systems, if there is a large system time difference between independent time systems corresponding to different systems, the systems may not work together, for example, in the virtual reality or augmented reality system, if time delay is too large, it will have a greater impact on the user experience. Therefore, it has become a research direction to improve the accuracy of time synchronization.

Taking the Network Time Protocol (NTP) as an example, the NTP is a protocol that synchronizes the time of each computer in the network, which is configured to synchronize the time and Universal Time Coordinated (UTC) of the computer to milliseconds level. In the synchronization mechanism of the NTP, more data interaction is required. When the network is unblocked, the time delay is usually about 10 milliseconds; when the network is congested, the time delay can reach 100 milliseconds or higher, which is difficult to meet the needs of some fields.

### SUMMARY OF THE DISCLOSURE

According to one aspect of the present disclosure, a time synchronization system is provided. The system includes a host, a first device and a second device, each of the host, the first device and the second device has a time system respectively. The first device is configured to send a first signal to the second device at a local time T2 of the first device according to a control command sent from the host, the first signal is a signal that transmitted in the wireless channel with a fixed duration. The second device is configured to receive the first signal sent from the first device at a local time T3 of the second device, and send first data carrying the time T3 to the host. The host is configured to acquire the time T2 from the control command, receive the first data carrying the time T3 sent from the second device, and determine a system time difference between the time systems corresponding to the first device and the second device according to the time T2, the time T3, and a preset ΔIR, wherein the ΔIR is a fixed duration of the first signal transmitted from the first device to the second device.

According to another aspect of the present disclosure, a data processing method is provided. The method performed by a host of a time synchronization system, the synchronization system includes a first device and a second device, wherein each of the host, the first device and the second device has a time system respectively. The method includes acquiring a time T2 from a control command, wherein the time T2 at which the first device sends a first signal to the second device, the first signal is a signal that transmitted in the wireless channel with a fixed duration; receiving first data carrying a time T3 sent from the second device, wherein the time T3 is the time at which the second device receives the first signal sent from the first device; determining a system time difference between the time systems corresponding to the first device and the second device, according to the time T2, the time T3, and a preset ΔIR, wherein the ΔIR is a fixed duration of the first signal transmitted from the first device to the second device.

According to yet another aspect of the present disclosure, a data processing method is provided. The method performed by a first device of a time synchronization system, the synchronization system further comprising a host and a second device, wherein each of the host, the first device and the second device has a time system respectively. The method includes sending a first signal to the second device at a local time T2 according to a control command sent from the host, wherein the first signal is a signal that transmitted in the wireless channel with a fixed duration, the fixed air duration consumed by the first device to transmit the first signal is ΔIR, so as to determining, by the host, a system time difference between the time systems corresponding to the first device and the second device according to the time T2, a time T3 and the ΔIR, wherein the time T3 is the time at which the second device receives the first signal sent from the first device.

### BRIEF DESCRIPTION OF THE DRAWINGS

In order to make the technical solution described in the embodiments of the present disclosure more clearly, the drawings used for the description of the embodiments will be briefly described. Apparently, the drawings described below are only for illustration but not for limitation. It should be understood that, one skilled in the art may acquire other drawings based on these drawings, without making any inventive work.

FIG. 1 is a schematic diagram of a time synchronization system, according to an embodiment of the present disclosure.

FIG. 2 is a schematic diagram of a data processing method, according to an embodiment of the present disclosure.

FIG. 3 is a schematic diagram of a host, according to an embodiment of the present disclosure.

FIG. 4 is a schematic diagram of another host, according to an embodiment of the present disclosure.

FIG. 5 is a schematic diagram of a first device, according to an embodiment of the present disclosure.

FIG. 6 is a schematic diagram of a second device, according to an embodiment of the present disclosure.

FIG. 7 is a schematic diagram of a host, according to an embodiment of the present disclosure.

### DETAILED DESCRIPTION

Embodiments of the present disclosure provide data processing method and device for improving the accuracy of the system time difference between time systems in the time synchronization system.

The technical solutions in the embodiments of the present disclosure are described in conjunction with the drawings in the embodiments of the present disclosure. It is obvious that the described embodiments are only a part of the embodiments of the present disclosure, and not all embodiments. All other embodiments obtained by the ordinary skilled in the art based on the embodiments in the present disclosure without the creative work are all within the scope of the present disclosure. It should be noted that similar reference numerals and letters indicate similar items in the following figures. Therefore, once an item is defined in a drawing, it is not necessary to further define and explain it in the subsequent drawings. Also, in the description of the present disclosure, the terms “first”, “second”, and the like are used merely to distinguish a description, and are not to be construed as indicating or implying a relative importance.

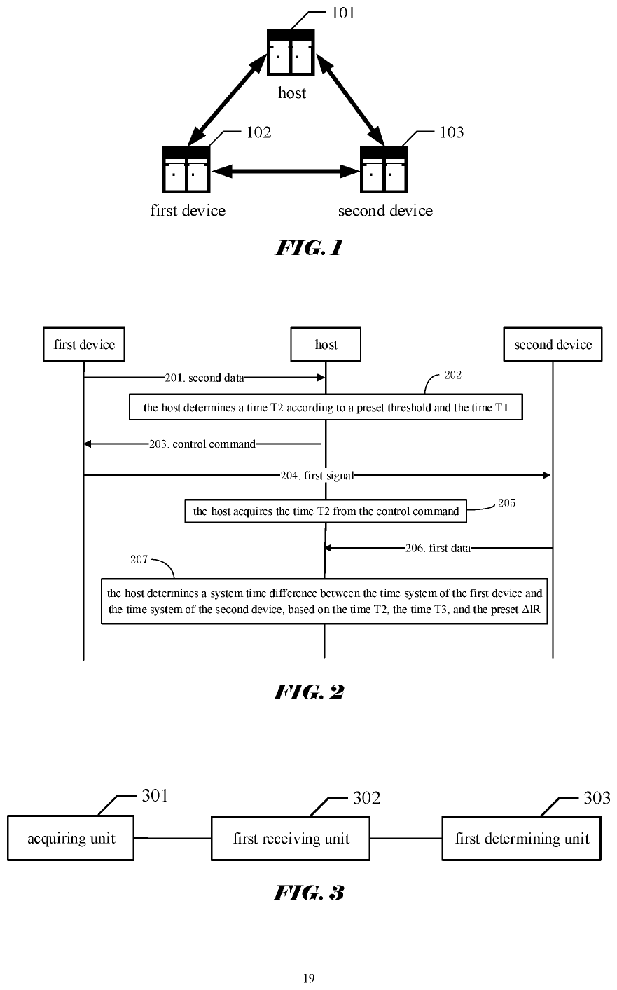

FIG. 1 is a schematic diagram of a time synchronization system according to an embodiment of the present disclosure. The time synchronization system includes a host 10, a first device 102, and a second device 103, wherein the host 101, the first device 102 and the second device 103 have independent time system, respectively. For example, when the timetable of the host is AM 12:10:00, the timetable of the first device is AM 11:00:10, the timetable of the second device is AM 11:00:20. As shown in FIG. 2, the host 101, the first device 102, and the second device 103 can communicate with each other.

It should be understood that, the number of the host, the first device, and the second device in the time synchronization system is not limited to one, and only one host, one first device, and one second device in FIG. 2 is described as an example. In actual applications, the number of the three may be appropriately increased if necessary, and there is no limitation herein.

In order to facilitate the understanding of the data processing method, the data processing method in the embodiment of the present disclosure will be described in detail below with reference to specific embodiments.

As shown in FIG. 2, a data processing method in first embodiment of the present disclosure includes actions/operations in the following blocks.

At block 201, the first device sends second data to the host, wherein the second data carries information of time T1.

In some embodiments, the first device sends the second data to the host, the second data carries the information of the time T1, wherein the time T1 is the local time at which the first device sends the second data to the host, the time T1 is the time of the time system of the first device.

In some embodiments, the second data may include other data, which is not limited herein.

In one embodiment, the first device generates a timestamp at time T1, and sends the timestamp in the second data to the host at time T1.

In one embodiment, the air duration that the first device sends the second data to the host is Δ1, wherein Δ1 may be a value randomly distributed between 0 to 100 ms in an actual application scenario.

At block 202, the host determines a time T2 according to a preset threshold and the time T1.

In one embodiment, when the host receives the second data sent from the first device, the host analyzes the information of the time T1 from the second data to get the time T1, then the host determines the time T2 according to the preset threshold and the time T1. The receiving time corresponding to the first device does not exceed the time T2 when the first device receives control command sent from the host subsequently, thereby it can be ensured that the first device can send a first signal to the second device at time T2, wherein the time T2 is the time of the time system of the first device.

If the air duration that the first device sends the second data to the host is Δ1, the host determines the time T2 greater than or equal to (T1+2*Δ1), according to the preset threshold and the time T1, wherein the preset threshold is 2*Δ1.

In addition, the preset threshold is related to the air duration that the first device sends the second data to the host, that is, Δ1, and it can be ensured that the first device can send the first signal (such as infrared signal) to the second device at time T2. The threshold can be 1.5*Δ1, 3*Δ 1, 2.5*Δ 1, or the like. The threshold value may be specifically determined according to the actual application scenario, which is not limited herein.

At block 203, the host sends a control command to the first device, wherein the control command is used to instruct the first device to send the first signal to the second device at time T2.

In one embodiment, the host sends a control command to the first device when the host determines the time T2 according to the preset threshold and the time T1, the control command is used to instruct the first device to send the first signal to the second device at time T2.

At block 204, the second device receives the first signal sent from the first device at time T3.

In one embodiment, after the first device receives the control command sent from the host to indicate that sends the first signal to the second device, it should be understood that the time at which the first device receives the control command does not exceed the time T2. When the time system in the first device reaches the time T2, the first device sends the first signal to the second device, such that the second device, at time T3, receives the first signal sent from the first device at time T2. It should be noted that, the time T3 corresponds to the time system of the second device. In addition, the consumed air time of the first signal from the first device transmitted to the second device through the wireless channel is a fixed air duration ΔIR.

In some embodiments, the first signal may include an infrared signal, and the air duration corresponding to the infrared signal is a fixed value.

At block 205, the host acquires the time T2 from the control command.

In one embodiment, after the host sends the control command to the first device, the host obtains information of the time T2 from the control command, and further obtains the time T2.

In some embodiments, since the time T2 is determined by the host in step 202, if the time T2 is saved in the local data of the host, the step 205 may not be performed, and the time T2 is directly obtained from the local data.

At block 206, the second device sends the first data to the host, wherein the first data carries information of time T3.

In one embodiment, after the second device receives the first signal at time T3, the second device sends the first data carrying time T3 to the host, such that the host acquires local time of the second device at which the second device receives the first signal, that is, the time T3.

At block 207, the host determines a system time difference between the time system of the first device and the time system of the second device, based on the time T2, the time T3, and the preset ΔIR.

In one embodiment, the host determines a system time difference between the time systems corresponding to the first device and the second device according to the time T2, the time T3, and the preset ΔIR, such that the synchronization system performs time synchronization based on the system time difference between the time systems of the devices.

In some embodiments, the preset ΔIR may be a consumed air duration of the infrared signal from the first device sends to the second device, and the host may determine the fixed air duration according to the encoding and decoding process of the infrared signal.

In some embodiments, the host brings the time T2, the time T3, and the preset ΔIR into a first formula to calculate a system time difference between the time systems corresponding to the first device and the second device, wherein the first formula can be: Δ12=T3-T2+ΔIR; in the first formula, Δ12 is the system time difference between the time systems corresponding to the first device and the second device; T3 is a time in the time system of the second device at which the second device receives the first signal sent from the first device; T2 is a time in the time system of the first device at which the first device sends the first signal to the second device; and ΔIR is the consumed air duration of the first signal from the first device transmitted to the second device.

In one embodiment, it can be understood that, the fixed air duration is a substantially fixed value, and therefore, the fixed air duration is ΔIR, and then the system time difference between the independent time systems corresponding to the first device and the second device are obtained according to the time T2, the time T3, and the preset ΔIR. Since the time T2, the time T3, and the preset ΔIR are relatively fixed values, the calculated system time difference is accurate, such that the time synchronization accuracy is improve.

The foregoing embodiment describes a data processing method in the embodiment of the present disclosure in detail. The following describes a time synchronization system in the embodiment of the present disclosure.

The time synchronization system includes a host, a first device, and a second device. The host, the first device, and the second device can communicate with each other separately. The following will describes the time synchronization system in the embodiment of the present disclosure, combined with the host, the first device, and the second device.

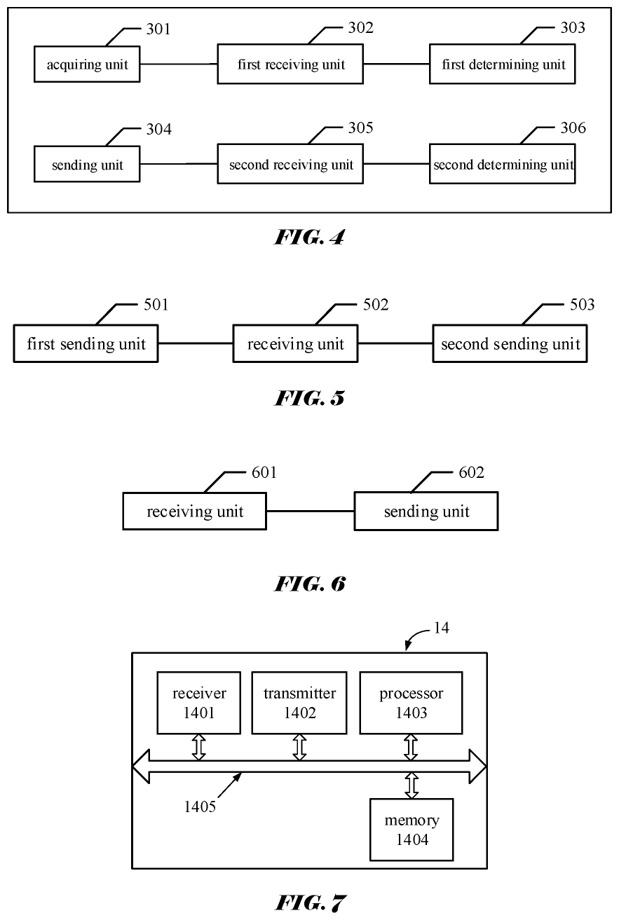

As shown in FIG. 3, a host is provided in second embodiment of the present disclosure, the host may include an acquiring unit 301, a first receiving unit 302, and a first determining unit 303.

The acquiring unit 301 is configured to acquire a time T2 from a control command, wherein the time T2 is a time when the first device sends a first signal to the second device, the air duration that transmitting the first signal in the wireless channel is a fixed duration.

The first receiving unit 302 is configured to receive, by the second device, a first data that carries the time T3, wherein the time T3 is a time when the second device receives the first signal sent from the first device;

The first determining unit 303 is configured to determine, based on the time T2, the time T3, and the preset ΔIR, a system time difference between time systems corresponding to the first device and the second device, wherein the ΔIR is a fixed duration transmitted of the first signal from the first device to the second device.

In a possible implementation, the first signal may be an infrared signal.

In some embodiments, as shown in FIG. 4, the host may further include a sending unit 304, wherein the sending unit 304 is configured to send the control command to the first device, the control command is used to control the first device to send the first signal to the second device at the time T2.

In some embodiments, as shown in FIG. 4, the host may further include a second receiving unit 305 and a second determining unit 306, wherein the two units are respectively configured to perform the following operations.

The second receiving unit 305 is configured to receive the second data sent from the first device, wherein the second data carries the information of the time T1, wherein the time T1 is a local time at which the first device sends the second data to the host.

The second determining unit 306 is configured to determine the time T2 according to the preset threshold and the time T1, such that the receiving time corresponding to the first device does not exceed the time T2 when the first device receives control command sent from the host, thereby it can be ensured that the first device can send a first signal to the second device at time T2.

It can be understood that, the fixed air duration is a substantially fixed value, and therefore, the fixed air duration is ΔIR, and then the system time difference between the independent time systems corresponding to the first device and the second device is obtained according to the time T2, the time T3, and the preset ΔIR. Since the time T2, the time T3, and the preset ΔIR are relatively fixed values, the calculated system time difference is accurate, such that the time synchronization accuracy is improve.

The second embodiment describes an embodiment of the host in detail. The first device in the embodiment of the present disclosure is described below with reference to a specific embodiment.

As shown in FIG. 5, the first device is provided in third embodiment of the present disclosure, the first device may include a first sending unit 501.

The first sending unit 501 is configured to send a first signal to the second device at a local time T2, wherein the first signal is a signal that transmitted in the wireless channel with a fixed duration. The fixed duration of the first device transmitting the infrared signal is ΔIR, such that the host determines the system time difference between the time systems corresponding to the first device and the second device according to the time T2 and the ΔIR.

In a possible implementation, the first signal may be an infrared signal.

In some embodiments, the first device may further include a receiving unit 502, which is configured to receive a control command sent from the host, wherein the control command is used to instruct the first device send the first signal to the second device at the time T2.

In some embodiments, the first device may further include a second sending unit 503, which is configured to send a second data carrying the time T1 to the host, wherein the time T1 is a local time at which the first device sends the second data to the host.

The air duration that transmitting the first signal in the wireless channel is a fixed duration, such that the calculated system time difference between time systems corresponding to the first device and the second device is accurate, according to the fixed duration ΔIR.

The third embodiment of the present disclosure provides a detailed description of an embodiment of the first device. The second device in the embodiment of the present disclosure is described below with reference to a specific embodiment.

As shown in FIG. 6, the second device is provided in fourth embodiment of the present disclosure, the second device may include receiving unit 601 and sending unit 602.

The receiving unit 601 is configured to receive the first signal sent from the first device at a local time T3, wherein the first signal is a signal that transmitted in the wireless channel with a fixed duration.

The sending unit 602 is configured to send the first data carrying the time T3 to the host, such that the host determines the system time difference between the time systems corresponding to the first device and the second device according to the time T3.

In one possible implementation, the first signal may be an infrared signal.

The second device receives the first signal sent from the first device, and sends the second data, which carries the time T3 corresponding to the local time that receives the first signal, to the host, such that the host acquires that the second device receives the first signal sent from the first device at time T2, and calculates the system time difference between the time systems corresponding to the first device and the second device.

The second, third and fourth embodiment describe the host, the first device, and the second device, respectively. The following implementation describes the host, the first device, and the second device in the embodiment of the present disclosure. It should be noted that, structure of the host, the first device, and the second device is similar, the fifth embodiment only describe the host, the structure of the first device and the second device will not be described herein.

As shown in FIG. 7, the host is provided in the fifth embodiment of the present disclosure, the host 14 may include a receiver 1401, a transmitter 1402, a processor 1403, memory 1404, and a bus 1405.

It should be noted that, the structure shown in FIG. 7 is also applicable to the first device and the second device.

The memory 1404 can include read only memory and random access memory, and provide instructions and data to the processor 1403. A portion of the memory 1404 may also include a non-volatile random access memory (NVRAM).

The memory 1404 stores the following elements, executable modules or data structures, or a subset thereof, or an extended set thereof. The elements may include operation instructions including various operation instructions for implementing various operations. The element may also include operating system including a variety of system programs for implementing various basic services and handling hardware-based tasks.

The processor 1403 may be used to perform operations corresponding to the host 14 in above embodiment, and may include the following operations: obtaining a time T2 from a control command, wherein the time T2 is a time when the first device sends a first signal to the second device, the first signal is a signal that transmitted in the wireless channel with a fixed duration; receiving the first data carrying the time T3 sent from the second device, wherein the time T3 is the time when the second device receives the first signal sent from the first device; determining a system time difference between the time systems corresponding to the first device and the second device according to the time T2, the time T3, and the preset ΔIR, wherein the ΔIR is a fixed duration of the first signal transmitted from the first device to the second device.

When FIG. 7 is applicable to the first device in the above embodiment, the processor 1403 in the embodiment of the present disclosure may be configured to perform operations corresponding to the first device in above embodiment, including: sending a first signal to the second device at a local time T2 of the first device, wherein the first signal is a signal that transmitted in the wireless channel with a fixed duration, the fixed air duration consumed by the first device to transmit the infrared signal is ΔIR, such that the host determines the system time difference between the time systems corresponding to the first device and the second device according to the time T2 and the ΔIR.

When FIG. 7 is applicable to the second device in the above embodiment, the processor 1403 in the embodiment of the present disclosure may be configured to perform operations corresponding to the second device in above embodiment, including: receiving the first signal sent from the first device at the local time T3, wherein the first signal is a signal that transmitted in the wireless channel with a fixed duration; sending the first data carrying the time T3 to the host, such that the host determines a system time difference between the time systems corresponding to the first device and the second device according to the time T3.

The processor 1403 controls the operation of the host 14. The processor 1403 may also be referred to as a central processing unit (CPU). Memory 1404 can include read only memory and random access memory, and provide instructions and data to processor 1403. A portion of the memory 1404 can also include an NVRAM. In a specific application, the various components of the host 14 are coupled together by a bus system 1405. The bus system 1405 may include a power bus, a control bus, a status signal bus, and the like, in addition to the data bus. For clarity of description, various buses are labeled as bus system 1405.

The method disclosed in above embodiment may be applied to the processor 1403 or implemented by the processor 1403. The processor 1403 may be an integrated circuit chip with signal processing capabilities. In the implementation process, each block of the above method may be completed by an integrated logic circuit of hardware in the processor 1403 or an instruction in a form of software. The processor 1403 may be a general-purpose processor, a digital signal processor (DSP), an application-specific integrated circuit (ASIC), ready-made programmable Gate array (FPGA) or other programmable logic devices, discrete gate or transistor logic devices, discrete hardware components. The methods and logical block diagrams disclosed in the embodiments of the present disclosure may be implemented or executed. The general purpose processor may be a microprocessor, any conventional processor, or the like. The blocks of the method disclosed in the embodiments of the present disclosure may be directly implemented by the hardware decoding processor, or may be performed by a combination of hardware and software modules in the decoding processor. The software module can be located in a conventional storage medium such as random access memory, flash memory, read only memory, programmable read only memory, electrically erasable programmable memory, registers, or the like. The storage medium is located in the memory 1404, the processor 1403 reads the information in the memory 1404 and completes the steps of the above method in combination with its hardware.

In above implementations, it may be implemented in whole or in part by software, hardware, firmware, or any combination thereof. When implemented in software, it may be implemented in whole or in part in the form of a computer program product.

The computer program product includes one or more computer instructions. When the computer program instructions are loaded and executed on a computer, the processes or functions described in accordance with embodiments of the present disclosure are generated in whole or in part. The computer can be a general purpose computer, a special purpose computer, a computer network, or other programmable device. The computer instructions can be stored in a computer readable storage medium or transferred from one computer readable storage medium to another computer readable storage medium, for example, the computer instructions can be transmitted from a web site site, computer, server or data center to another web site site, computer, server, or data center by wire (eg, coaxial cable, fiber optic, digital subscriber line) or wireless (eg, infrared, wireless, microwave). The computer readable storage medium can be any available media that can be stored by a computer or a data storage device such as a server, data center, or the like that includes one or more available media. The usable medium may be a magnetic medium (eg, a floppy disk, a hard disk, a magnetic tape), an optical medium (eg, a DVD), or a semiconductor medium (such as a solid state disk).

A person skilled in the art can clearly understand that, for the convenience and brevity of the description, the specific working process of the system, the device and the unit described above can refer to the corresponding process in the foregoing method embodiment, which is not described herein again.

It should be understood that, in the several embodiments provided by the present disclosure, the disclosed system, apparatus, and method may be implemented in other manners. For example, the embodiments of device described above are merely illustrative, the division of the unit is only a logical function division. There may be another division manner in actual implementation, for example, multiple units or components may be combined or integrated into another system, or some features can be ignored or not executed. In addition, the mutual coupling, direct coupling or communication connection shown or discussed may be an indirect coupling or communication connection through some interface, device or unit, and may be in an electrical, mechanical or other form.

The units described as separate components may be or may not be physically separated, and the components displayed as units may be or may not be physical units, that is, may be located in one place, or may be distributed to multiple network units. Some or all of the units may be selected according to actual needs to achieve the purpose of the solution of the embodiment.

In addition, each functional unit in each embodiment of the present disclosure may be integrated in one processing unit, or each unit may exist physically separately, or two or more units may be integrated in one unit. Above integrated unit can be implemented in the form of hardware or in the form of a software functional unit.

The integrated unit, if implemented in the form of a software functional unit and sold or used as a standalone product, may be stored in a computer readable storage medium. Based on such understanding, the technical solution of the present disclosure, which is essential or contributes to the prior art, or all or part of the technical solution, may be embodied in the form of a software product. The computer software product is stored in a storage medium and includes instructions for causing a computer device (which may be a personal computer, server, or network device, etc.) to perform all or part of the steps of the methods described in various embodiments of the present disclosure. The above storage medium includes a U disk, a mobile hard disk, a read-only memory (ROM), a random access memory (RAM), a magnetic disk, an optical disk, or the like.

The embodiments of the present disclosure have been described in detail above, and the principles and implementations of the present disclosure are described in the specific examples. The description of the above embodiments is only used to help understand the method of the present disclosure and its core ideas. For a person skilled in the art, there will have a change in the specific embodiments and the scope of present disclosure according to the idea of the present disclosure. In summary, the content of the present specification should not be construed as limiting the present disclosure.

What is claimed is:

1. A time synchronization system, comprising a host, a first device and a second device, each of the host, the first device and the second device has a time system respectively;
wherein the first device is configured to send a first signal to the second device at a local time T2 of the first device according to a control command sent from the host, the first signal is a signal that transmitted in the wireless channel with a fixed duration;
the second device is configured to receive the first signal sent from the first device at a local time T3 of the second device, and send first data carrying the time T3 to the host;
the host is configured to acquire the time T2 from the control command, receive the first data carrying the time T3 sent from the second device, and determine a system time difference between the time systems corresponding to the first device and the second device according to the time T2, the time T3, and a preset ΔIR, wherein the ΔIR is a fixed duration of the first signal transmitted from the first device to the second device.

2. The system of claim 1, wherein the host further configured to send the control command to the first device, which is configured to instruct the first device to send the first signal to the second device at time T2.

3. The system of claim 1, wherein the first device further configured to send second data carrying a time T1 to the host, wherein the time T1 is a local time of the first device at which the first device sends the second data to the host;
the host further configured to determine the time T2 according to a preset threshold and the time T1, the time that the first device receives the control command sent from the host does not exceed the time T2.

4. The system of claim 3, wherein the preset threshold is related to an air duration of the second data transmitted from the first device to the host.

5. The system of claim 3, wherein the host further configured to determine the time T2 greater than or equal to (time T1+2*Δ1), the Δ1 is an air duration of the second data transmitted from the first device to the host, the preset threshold is 2*Δ1.

6. A data processing method performed by a host of a time synchronization system, the synchronization system further comprising a first device and a second device, wherein each of the host, the first device and the second device has a time system respectively, the method comprising:
acquiring a time T2 from a control command, wherein the time T2 at which the first device sends a first signal to the second device, the first signal is a signal that transmitted in the wireless channel with a fixed duration;
receiving first data carrying a time T3 sent from the second device, wherein the time T3 is the time at which the second device receives the first signal sent from the first device;
determining a system time difference between the time systems corresponding to the first device and the second device, according to the time T2, the time T3, and a preset ΔIR, wherein the ΔIR is a fixed duration of the first signal transmitted from the first device to the second device.

7. The method of claim 6, further comprising:
prior to acquiring a time T2, sending the control command to the first device, which is configured to instruct the first device to send the first signal to the second device at time T2.

8. The method of claim 7, further comprising:
prior to sending the control command to the first device, receiving second data sent from the first device, wherein the second data carries information of a time T1 which is a local time of the first device at which the first device sends the second data to the host;
determining the time T2 according to a preset threshold and the time T1, the time that the first device receives the control command sent from the host does not exceed the time T2.

9. The method of claim 8, wherein the preset threshold is related to an air duration of the second data transmitted from the first device to the host.

10. The method of claim 8, wherein determining the time T2 according to a preset threshold and the time T1, comprises:
determining the time T2 greater than or equal to (time T1+2*Δ1), wherein the Δ1 is an air duration of the second data transmitted from the first device to the host, the preset threshold is 2*Δ1.

11. A data processing method performed by a first device of a time synchronization system, the synchronization system further comprising a host and a second device, wherein each of the host, the first device and the second device has a time system respectively, the method comprising:
sending a first signal to the second device at a local time T2 according to a control command sent from the host, wherein the first signal is a signal that transmitted in the wireless channel with a fixed duration, the fixed air duration consumed by the first device to transmit the first signal is ΔIR, so as to determining, by the host, a system time difference between the time systems corresponding to the first device and the second device according to the time T2, a time T3 and the ΔIR, wherein the time T3 is the time at which the second device receives the first signal sent from the first device.

12. The method of claim 11, further comprising:
prior to sending a first signal to the second device, receiving the control command sent from the host, which is configured to instruct the first device to send a first signal to the second device at time T2.

13. The method of claim 11, further comprising:
prior to receiving the control command sent from the host, sending second data carrying a time T1 to the host, wherein the time T1 is a local time of the first device at which the first device sends the second data to the host.

14. The method of claim 13, wherein the time T2 is determined according to a preset threshold and the time T1, and the preset threshold is related to an air duration of the second data transmitted from the first device to the host.

15. The method of claim 14, wherein the time T2 determined is greater than or equal to (time T1+2*Δ1), wherein the Δ1 is an air duration of the second data transmitted from the first device to the host, the preset threshold is 2*Δ1.
